(19) United States
(12) Patent Application Publication
(10) Pub. No.: US 2017/0049104 A1
(43) Pub. Date: Feb. 23, 2017

(54) COMBINATIONS AND METHODS FOR CONTROL OF INSECT PESTS USING REDUCED RATES OF TOXICANTS

(71) Applicant: Lure-Labs, LLC, Scottsdale, AZ (US)

(72) Inventor: John McClure, Scottsdale, AZ (US)

(21) Appl. No.: 15/308,009

(22) PCT Filed: May 7, 2015
(86) PCT No.: PCT/US15/29777

§ 371 Date: Oct. 31, 2016

Related U.S. Application Data
(60) Provisional application No. 61/989,925, filed on May 7, 2014.

(51) Int. Cl. A01N 43/56; A01N 31/14; A01N 25/02; A01N 51/00; A01N 43/36

(52) U.S. Cl. CPC A01N 43/56; A01N 51/00; A01N 43/36; A01N 25/02; A01N 31/14

(57) ABSTRACT

The present disclosure relates to compositions and methods for control of insect pests using reduced rates of toxicants. In an exemplary embodiment, a termiticide composition comprises a toxicant, an attractant and an additive, wherein the effective rate of the toxicant is substantially reduced relative to an effective rate of the toxicant in a commercial formulation. The additive may comprise a cellulose ether, a cellulosic bait, or an adjuvant. A method for controlling termites using a reduced rate of toxicant comprises treating an area to be protected against termites using a treatment solution comprising an admixture of a toxicant, an attractant, and an additive. The method for controlling termites provides effective control using a rate of toxicant that is substantially lower than a commercial formula toxicant rate due to admixture of the attractant and the additive with the toxicant.

### FIELD

The present disclosure relates generally to combinations and methods for control of insect pests. More particularly, the disclosure relates to combinations for controlling termites that comprise toxicants, attractants, and baits, and methods of using such combinations to kill termites or prevent infestation.

### BACKGROUND

Subterranean termites (Rhinotermitidae) are the most common termite type and do the most damage of all termite species. They live in large underground colonies of several thousand to several million individuals, and consume cellulosic materials in the surrounding environment. Two common and destructive genera of subterranean termites are Reticulitermes and Coptotermes. Reticulaermes is the principle termite pest in the Northern Hemisphere, and is found in Canada, the US, Mexico, Europe, southern Russia, the Middle East, northern Africa, India, Korea, Japan, and China. However, the Formosan subterranean termite (Coptotermes formosanus) is the most destructive of all termite species, accounting for 95% of all termite damage. Introduced to the US from Asia, this exotic pest has spread throughout many southern states. A third destructive genus of subterranean termite is Heterotermes, with Heterotermes aureaus representing another major termite pest in the US. Other termites are significant pests of crops, including such principal tropical food crops as rice, maize, sorghum, and sugarcane, in various parts of the world such Africa, South America, and Asia. Countries such as Brazil and India, as well as many African countries, experience significant economic losses due to termite activity in crops. Species of termite from the genera Trinervitermes, Odontotermes, Andtermes, Microtermes, Cylindrotermes, and Syntermes, among others, contribute to crop damage caused by termites.

Termites present a serious threat to structures, particularly residential structures, as well as agronomic crops, throughout most of the United States and around the world. Property and crop damage caused by termites is estimated in the billions of dollars annually. The damage cause by termites is the result of their contact with and consumption of cellulosic materials used as building materials, such as lumber, as well as tissues of agronomic crops. Termites access and infest food sources through underground and above ground tunnels extending between a colony nest and the food source. In many cases, termite damage can be prevented by the appropriate use of termite control agents such as insecticidal chemicals that cause toxicity or mortality in termites. Such chemicals are also referred to as termiticides.

One of the most widely used techniques to combat termite infestation is the application of termiticides to the ground under and/or around a structure or crop. Typically, termiticides are applied directly to the soil near the structure or crop to be protected, forming a subterranean barrier that kills termites that attempt to pass through the barrier. Despite their benefit in controlling infestation of damaging termites, termiticides may have hazardous environmental effects due, in part, to their long half-lives, as well as the nature of the residues or degradation products they leave in the environment.

The environmental effects of pesticide use on non-target organisms are of increasing concern to consumers and subject to increased scrutiny by regulatory agencies. The use of some termiticidal compounds, for example, chlorpyrifos, has been discontinued due to environmental safety concerns and identification of residual effects on human health. Uses of other pesticides, for example, fipronil, have been severely restricted in crops. However, research for the development of new active compounds, as well as the demonstration of their efficacy and safety in the long term, is both costly and time consuming Continued use of existing compounds with proven efficacy against termite infestation is likely to be required to continue to reduce economic losses caused by termites and other insect pests. That being said, measures to reduce environmental accumulation of active compounds and their degradation products are desirable to reduce the level of unintended consequences with regard to non-target species. Therefore, termiticidal and insecticidal combinations that utilize approved toxicants and demonstrate comparable efficacy to currently available commercial formulations, but achieve efficacy using decreased rates of toxicant in combination with non-pesticide compounds that enhance performance of the toxicant, are desirable.

### SUMMARY

In accordance with various embodiments, the ability to control termites using decreased rates of toxicant chemicals is improved by providing compositions and methods that provide an effective rate of toxicant that is decreased relative to commercial formulations of the toxicant. As set forth in more detail below, the various advantages of the composition and methods of the embodiments disclosed herein include the ability to maintain effective protection against subterranean termites while reducing potential ecotoxicity due to the use of decreased rates of toxicant.

In various embodiments, a termiticide composition is provided that comprises a toxicant, an attractant, and an additive. In accordance with various embodiments, a finished solution of the termiticide composition is suitable for application by spraying. In various embodiments, the termiticide composition comprises an effective rate of a toxicant in a finished solution of the termiticide composition that is substantially reduced relative to the effective rate of the same toxicant in a commercial formulation comprising the toxicant.

In various embodiments, a termiticide composition comprises a toxicant, an attractant and an additive. In accordance with various embodiments, the additive comprises an adjuvant or a cellulosic bait. In various embodiments, a finished solution of the termiticide composition is sprayable. In accordance with various embodiments, the adjuvant provides for improved toxicant performance, such that the termiticide composition achieves termite control that is substantially comparable to the termite control provided by a commercial formulation comprising the same toxicant, while using a rate of toxicant that is substantially reduced as compared to the rate of toxicant in the commercial formulation.

In accordance with various embodiments, a method of controlling termites using a reduced rate of toxicant is provided. In various embodiments, the method comprises treating an area to be protected against termites with a composition comprising an admixture of a toxicant, an attractant, and an additive. In accordance with various embodiments, an additive comprises at least one of a cellulose ether, a cellulosic bait, or an adjuvant. In accordance with various embodiments, the toxicant is selected from a group comprising non-repellent termiticides. In accordance with further aspects of the embodiments, the effective rate of the toxicant is substantially lower than an effective rate of the toxicant in a commercial formulation due to admixture of the attractant and the additive with the toxicant in the disclosed composition.

In various embodiments, another method of controlling termites using a reduced rate of toxicant is provided. In accordance with various embodiments, the method comprises selecting a toxicant from a group of chemicals comprising non-repellent termiticides, selecting an additive, selecting an attractant, and admixing the termiticide, additive, and attractant into a flowable concentrate. In accordance with further aspects of the embodiment, the method comprises diluting the concentrate to form a finished solution and applying the finished solution to an area to be protected. In various embodiments, the effective rate of the toxicant in the finished solution is substantially lower than an effective rate of the toxicant in a commercial formulation.

In various embodiments, a method of improving plant vigor is provided. In accordance with various embodiments, the method comprises administering a formulation comprising a termiticide, an attractant, and an additive. In accordance with further aspects of the embodiment, the termiticide is fipronil. In accordance with further embodiments, the attractant is a pheromone.

### BRIEF DESCRIPTION OF THE DRAWINGS

The subject matter of the present disclosure is particularly pointed out and distinctly claimed in the concluding portion of the specification. A more complete understanding of the present invention, however, may best be obtained by referring to the detailed description when considered in connection with the drawing figures, wherein:

FIG. 1 illustrates a glass tube arena set-up of a termite tunneling bioassay.

FIG. 2 illustrates mean percent mortality of Reticulitermes flavipes in soil treated with fipronil 0.03% plus attractant (striped bars) versus untreated control (dotted bars) over time. Error bars: +1-1 standard error (SE).

FIG. 3 illustrates mean percent mortality of Coptotermes formosanus in soil treated with 0.03% fipronil plus attractant (striped bars) versus untreated control (dotted bars) over time. Error bars: +/−1 standard error (SE).

FIG. 4 illustrates mean distance tunneled (mm) by Reticulitermes flavipes in soil treated with fipronil 0.03% plus attractant (striped bars) versus untreated control (dotted bars) over time. Error bars: +/−1 standard error (SE).

FIG. 5 illustrates mean distance tunneled (mm) by Coptotermes formosanus in soil treated with 0.03% fipronil plus attractant (striped bars) versus untreated control (dotted bars) over time. Error bars: +/−1 standard error (SE).

FIG. 6 illustrates a diagram of a test cell in accordance with exemplary embodiments of the present invention.

FIG. 7 illustrates the effect on the number of tillers 60 days after treatment with various insecticides in the presence and absence of pheromone. 0=no termites; 1=˜1 to ˜10 termites; 2=˜11 to ˜100 termites; 3=more than 100 termites.

FIG. 8 illustrates the effect on the number of termites 60 and 120 days after treatment with various insecticides in the presence and absence of pheromone. 0=no termites; 1=˜1 to ˜10 termites; 2=˜11 to ˜100 termites; 3=more than 100 termites.

### DETAILED DESCRIPTION

The detailed description of various embodiments herein makes reference to various embodiments and implementations thereof by way of illustration and best mode, and not of limitation. While these embodiments are described in sufficient detail to enable those skilled in the art to practice the embodiments, it should be understood that other embodiments may be realized and that mechanical and other changes may be made without departing from the spirit and scope of this disclosure. Rather, the following disclosure is intended to teach both the implementation of the various embodiments and any equivalent embodiments. Furthermore, any reference to singular includes plural embodiments, and any reference to more than one component may include a singular embodiment. Moreover, recitation of multiple embodiments having stated features is not intended to exclude other embodiments having additional features or other embodiments incorporating different combinations of the stated features. As used in this disclosure, the term “or” shall be understood to be defined as a logical disjunction (e.g., and/or) and shall not indicate an exclusive disjunction unless expressly indicated.

As set forth in more detail below, various embodiments described herein provide significant advancements over prior art combinations and processes, particularly with regard to the ability to effectively control termites using combinations and processes that rely on termite toxicants alone. Furthermore, the combinations and processes disclosed herein permit use of reduced quantities of biologically active and potentially ecotoxic chemicals in the environment while still achieving a similar level of termite control as compared to commercial formulations of termiticides. Moreover, the composition and methods provided in the present disclosure are compatible with existing spraying and application equipment and methods, and therefore the many commercial benefits the present disclosure provides may be readily realized.

Various commercial formulations of non-repellant termite toxicants are currently available and labeled for use in providing protection against termite infestation and feeding on structures comprising cellulosic materials, such as lumber, that would serve as a food source for termites. The rate, concentration, or quantity of a toxicant in finished solutions of these commercial formulations, prepared according to the directions on the respective labels, represents the effective rate of the toxicant in a finished solution of a commercial formulation, as defined herein and used as a benchmark against which to compare the effective rate of the compositions and methods of the present disclosure. The term effective rate, as used herein, is further defined as a rate, concentration, or quantity of a toxicant in a solution, or as applied, that is capable of conferring a measurable or appreciable level of termite control or protection to the treated area. The commercial formulations described in the following paragraphs are included by way of reference and example only, and not by way of limitation. Toxicants other than those found in the commercial products described below may also be used in the compositions and methods of the present disclosure. Furthermore, although the methods and rates of application found in the labels of some of the commercial products described below for protection of structures or for use in agriculture are the same or similar, the compositions and methods of the present invention are not limited to those methods and rates of application. Rather, the advantages of the compositions and methods disclosed herein may be appreciated when used with the toxicant component of any commercial non-repellent termiticide or pesticide product, and prepared and applied in a manner similar to or different from that of the commercial termiticide or pesticide containing the same toxicant.

TERMIDOR® is the trade name for a commercial termiticide formulation comprising fipronil ((RS)-5-amino-1-[2,6-dichloro-4-(trifluoromethyl)phenyl]-4-trifluoromethylsulfinyl)-1H-pyrazole-3-carbonitrile). TERMIDOR® SC is a product of BASF Corporation, Research Triangle Park, N.C. TERMIDOR® SC is formulated as a water soluble liquid concentrate containing 9.1% active ingredient. TERMIDOR® SC is labeled for use at 0.06%-0.125% finished solution, with a 0.06% finished solution recommended for typical control situations. PREMISE is the trade name for a commercial termiticide formulation comprising imidacloprid (1-[(6-chloro-3-pyridinyl)methyl]-N-nitro-2-imidazolidinimine PREMISE 2 and is a product of the Bayer CropScience LP, Research Triangle Park, N.C. PREMISE 2 is formulated as a water soluble liquid concentrate containing 21.4% active ingredient. A 0.05% finished solution is generally recommended for typical control situations. PHANTOM® is the trade name for a commercial termiticide-insecticide formulation comprising chlorfenapyr (4-bromo-2-(4-chlorophenyl)-1-(ethoxymethyl) 5-(trifluoromethyl)-1H-pyrrole-3-carbonitrile). PHANTOM® is a product of BASF Corporation. PHANTOM® is formulated as a water soluble liquid concentrate containing 21.45% active ingredient. A 0.125%-0.25% finished solution is generally recommended for control of subterranean termites. TERMIDOR® SC, PREMISE 2, and PHANTOM® are intended to be applied in a manner to provide a continuous chemical barrier to prevent termites from attacking the area to be protected. The recommended rate of application for each commercial formulation is 4 gallons of finished solution per 10 linear feet per foot of depth, or 1 gallon per 10 square feet for horizontal soil barriers.

Other examples of termiticides or broad spectrum pesticides intended for crop use and against which the compositions and methods of the present disclosure may be compared include REGENT® (BASF Corporation), ENGEO® (Syngenta), and GAUCHO™ (Bayer CropScience), to name a few. The permissible, on-label uses of these and other pesticide products and the toxicants used in these pesticides, as well as their rates and methods of application, may vary between the countries that they are used in according to the agronomic or structural protection needs of those countries and their regulatory framework regarding use of agrichemicals. For example REGENT® 4SC, which includes fipronil as the toxicant, is labeled for in-furrow use on potatoes only in the US, and use on corn was recently removed from the label. However, in Brazil, the same product is used for control of termites and other pests in sugarcane. Again, the benefits of the compositions and methods of the present disclosure may be realized using various toxicants and various rates and methods of application for the same toxicant, as compared with commercial termiticide or pesticide formulations using the same toxicant, in a manner that depends on the locations in which the compositions or methods are used and the applications for which they are used.

Another example of a termiticide and broad spectrum pesticide intended for seed use and against which the compositions and methods of the present disclosure may be compared is DURSBAN (Dow AgroSciences). In India, DURSBAN may be applied for control of termites, as well as other insect pests, in crops such as barley and wheat. In addition to being used for protection of growing crops, DURSBAN may also be applied as a seed treatment for termite protection. In accordance with various embodiments, the compositions and methods of the present disclosure may be used in comparable formulations and applications to provide a reduced rate of toxicant application while providing effective termite control in seed treatment applications.

Generally, chemicals that may be effective as termiticides or insecticides are derived from a variety of chemical classes, including pyrethroids, organophosphates, organochlorine compounds, carbamates, benzoyl ureas, organic tin compounds, pyrazoles, macrolides, chloronicotinyl compounds, diacylhydrazines, phenylpyrazoles, as well as other non-classified compounds such as chlorfenapyr, pymetrozine, and diafenthruion, to name several examples.

The compositions and methods of the present disclosure may comprise any termiticidal or broad spectrum insecticidal toxicant from any of the chemical classes described above, as well as any chemical compounds from other chemical classes or unclassified chemical compound. In accordance with various embodiments, the toxicant is commercially available and approved for use by the EPA for compositions and methods to be used in the US. In accordance with other embodiments, the toxicant is commercially available and approved for use by the respective regulatory agencies of various foreign countries in which the compositions and methods are intended to be used. Preferably, the selected toxicant cannot be detected by termites or is non-repellent to termites. However, any termiticidal or insecticidal chemical compound, whether known or yet to be discovered, is within the scope of the present disclosure.

The concentrations of the toxicants used in the commercial formulations listed above, as specified by their respective labels for use in control of termites or other pests, and the rate of application of a finished solution specified in the labels (i.e., on a volume per square foot or volume per linear foot basis), comprise the toxicant rates or effective rates of the various commercial formulations, as used herein. The performance of a toxicant in a solution or composition prepared and applied according to the label of a commercial product containing the toxicant, along with the toxicant rate provided in the commercial formulation, represents the performance standard against which the compositions and methods of the present disclosure are compared in determining the efficacy of the disclosed compositions in achieving control of termites and/or other insect pests. In accordance with various embodiments, the compositions disclosed herein achieve termite control that is substantially similar to the termite control provided by commercial formulations of a termiticide that uses the same toxicant. In accordance with further aspects, a substantially similar level of termite control is achieved using substantially reduced rates of toxicant, as compared to the rate of toxicant in a commercial formulation of a termiticide that uses the same toxicant. In accordance with various embodiments, a reduced rate of toxicant may be achieved by providing a finished solution having a substantially reduced concentration of toxicant relative to a commercial formulation containing the same toxicant, when the two finished solutions would be applied in the same manner, for example, to create a continuous vertical barrier around the perimeter of a structure.

In accordance with various embodiments, the effective rate of a toxicant in a termiticide composition as disclosed herein is at least 10% less than the effective rate of the toxicant in a commercial formulation. In accordance with various other embodiments, the effective rate of a toxicant in a termiticide composition as disclosed herein is at least 30% less than the effective rate of the toxicant in a commercial formulation. In accordance with still other embodiments, the effective rate of a toxicant in a termiticide composition as disclosed herein is at least 50% less than the effective rate of the toxicant in a commercial formulation.

In accordance with various other embodiments, a reduced rate of toxicant is achieved by the manner in which a composition disclosed herein is applied. For example, a finished solution of a composition in accordance with the present disclosure that is intended for application to protect a discrete structure may have the same concentration of toxicant as a finished solution of a commercial formulation prepared according to the product label and intended for application to protect the same discrete structure. In this example, a finished solution of the composition of the present disclosure may be applied in a manner that is discontinuous (i.e., an interrupted barrier, or a barrier having loopholes), thereby requiring a decreased volume of finished solution and thus a decreased rate of toxicant relative to a commercial formulation that would be applied as a continuous barrier, while yet conferring termite control that is substantially similar to that provided by the continuous barrier of the applied commercial formulation. In accordance with still other embodiments, a finished solution of a composition in accordance with the present disclosure may have both a reduced concentration of toxicant and be applied as a discontinuous barrier and confer termite control that is substantially similar to that provided by the continuous barrier of the applied commercial formulation.

In accordance with various embodiments, a disclosed composition may be applied for protection of agricultural crops as a continuous or discontinuous barrier in a manner similar to that described in the examples above with respect to structures and confer termite or pest control that is substantially similar to that conferred by application of a commercial formulation while using a decreased rate of toxicant relative to the commercial formulation.

An attractant in accordance with various embodiments of the present disclosure includes any attractant, such as a chemical attractant. These may include food odor attractants, aggregation attractants, or insect pheromone-related attractants. For example, an aggregation (or pheromone-related) attractant in accordance with various embodiments of the present invention may include n-hexanoic acid. Other attractants may include aliphatic food odor attractants, for example, (Z,Z,E)-3,6,8-dodecatien-1-ol, or aromatic food odor attractants, such as 4-hydroxybenzoic acid. Other aliphatic and aromatic food odor attractants are known, and the attractants disclosed in U.S. Pat. No. 5,756,114 are herein incorporated by reference in its entirety and may serve as attractants in accordance with various embodiments of the present disclosure. The attractants disclosed in U.S. Pat. No. 6,352,703 are also incorporated by reference in its entirety. In various embodiments, 2-phenoxyethanol serves as an attractant. In accordance with embodiments, an attractant comprises at least one pheromone. In accordance with various embodiments of the present disclosure, any chemical or substance that serves to attract termites, whether known or yet to be discovered, may serve as an attractant.

In accordance with further aspects, a disclosed composition may optionally comprise an additive. An additive, in accordance with the present disclosure, comprises at least one cellulosic bait, cellulose ether, or adjuvant.

In accordance with further embodiments, an additive may comprise a cellulosic bait, for example, cellulose ether. A cellulose ether may be used as a cellulosic bait material in accordance with the present disclosure and may be a substance in which one or more hydroxyl groups of cellulose are etherized. In a cellulose ether, cellulose is typically alkylated by at least one moiety selected from the group consisting of alkyl groups (e.g., methyl, ethyl, propyl, or butyl), hydroxyalkyl groups (e.g., hydroxyethyl or hydroxypropyl) or carboxyalkyl groups (e.g., carboxymethyl). When cellulose is alkylated by carboxyalkyl group, the cellulose ether may be a salt such as alkali metal salt. Examples of cellulose ether include methylcellulose, ethylcellulose, hydroxyethylcellulose, hydroxypropylcellulose, ethylhydroxyethylcellulose, hydroxypropylmethylcellulose, carboxymethylcellulose, carboxymethylethylcellulose and sodium carboxymethylcellulose. Preferable examples of cellulose ether include methylcellulose, hydroxypropylcellulose, hydroxypropylmethylcellulose, carboxymethylcellulose and sodium carboxymethylcellulose. In accordance with various embodiments, an additive may be combined with an attractant. In various embodiments, an attractant may be combined with a cellulose ether bait, for example, 2-phenoxyethanol and carboxymethylcellulose. A composition in accordance with various embodiments may comprise a certain quantity of cellulosic bait material relative to a quantity of toxicant in the composition. For example, in various embodiments, a composition may include 0.085 grams of carboxymethylcellulose per 1.13 grams of fipronil.

In accordance with further embodiments, an additive may comprise an adjuvant. An adjuvant in accordance with the present disclosure may be any substance, compound, or combination thereof used in a composition or method that enhances the efficacy of a toxicant also used in the composition or method in conferring effective termite or insect pest control or protection.

In various embodiments, a composition in accordance with the present disclosure may be provided as a co-pack. A co-pack in accordance with the present disclosure, also referred to as a multi-pack, is packaged version of the composition wherein one or more components of the composition are packaged in one container separately from one or more additional components of the composition in at least a second container, and two or more containers together comprising all of the components of the composition are sold or distributed as a single unit. For example, a composition may be provided as a concentrated solution of a toxicant in one container and a separate concentrated solution of an additive in a second container. The separate concentrated solutions of toxicant and additive or portions thereof may be combined into a single container and diluted to create a finished solution of the composition for application to an area to be protected. A cop-pack in accordance with the present disclosure may be any combination of components of a composition in accordance with the present disclosure, wherein the components are divided among at least two containers.

An area to be protected in accordance with the present disclosure may comprise a building or other structure, an agronomic field, crop, or plant stock, or a seed stock. In accordance with various embodiments, finished solutions of the compositions disclosed herein are sprayable liquids that can be applied, for example, to soil adjacent to structures or crops to be protected or to any other substrate or surface in the same manner as is used for the application of conventional termiticides and pesticides. In various embodiments, finished solutions have a viscosity suitable for application with a conventional pressure spray applicator. In accordance with other aspects of the embodiments, finished solutions of the compositions disclosed herein can penetrate soil to depths comparable to finished solutions of commercial termiticide formulations.

In addition to providing protection of structures and/or crops against damage caused by termites via application to the soil, the compositions of the present disclosure may further provide a broad spectrum of pest or insect control. Although the commercial formulations referred to in the present disclosure and the toxicants therein are described with reference to control of termites, these same toxicants may also provide control of other insect pests. Therefore, the compositions and methods of the present disclosure are not limited for use against termites, but may also be useful to provide, for example, crop protection against insect pests including termites as well as other insect pests. In accordance with various embodiments, the compositions and methods of the present disclosure may be used for the protection of crops such as sugar cane, corn, or potatoes.

In accordance with various embodiments, the compositions of the present disclosure may be used in a manner suitable for application to a crop or to plant stock directly, to the soil surrounding or adjacent to a crop, or to seed as a seed treatment. For example, compositions disclosed herein may be sprayed over growing crops to treat both plants and soil in a field to be protected, or they may be applied in furrows adjacent to rows of crops such as corn, sugarcane, or potatoes. In another example, compositions disclosed herein may be prepared as slurries for the treatment of corn, wheat, barley, or any other grain or seed. Any physical form of the compositions disclosed herein, as well as any form of finished or working preparation of the composition, and any means of application to a structure or agronomic crop, seed, or commodity is within the scope of the present disclosure.

In accordance with various embodiments, the compositions of the present disclosure may be used to improve the vigor of a plant. As used herein “improving the vigor” of a plant, for example a sugar cane plant, means any of improving plant growth rate, plant weight, plant height, plant canopy, plant visual appearance, or plant health, or any combination of these factors. In further embodiments the improvement may be determined by measurable or noticeable change over time. In further embodiments the improvement may be measured against a control, such as where one or more factors are measured against a comparison plant produced under the same conditions, but without application of the subject compositions or methods described herein. In further embodiments, such factor(s) is increased or improved by a statistically significant amount. In further embodiments, improving the vigor of a sugar cane plant may be measured by the number of tillers produced, such as over a given period of time. The treatments disclosed herein may increase the number of tillers of a sugar cane plant, resulting in an improvement in vigor of that plant.

The following examples are provided to aid understanding of composition and methods of the present disclosure. They should not be used to restrict or limit the present disclosure.

### Example 1

The effectiveness of 0.03% fipronil plus attractant in producing mortality and reduced tunneling in Reticulitermes flavipes and Coptotermes formosanus was evaluated using an in vitro bioassay.

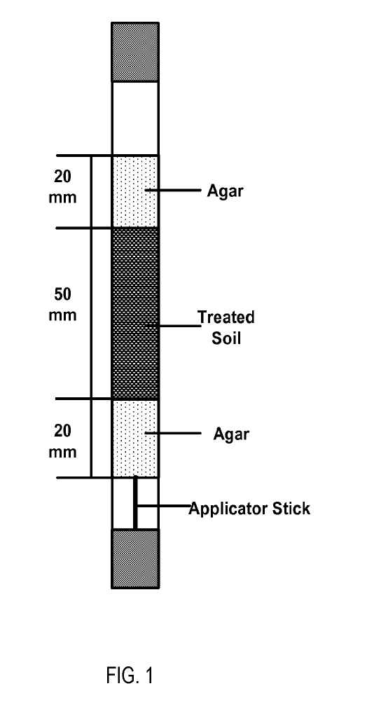

Five replications of each treatment were used for this test. Arenas consisted of glass tubes measuring 15×1.5 cm, with each tube having 50 mm of treated soil located between 20 mm of agar (FIG. 1). Arenas further consisted of approximately 20 mm of airspace between the sealed ends of the tubes and the agar. Twenty worker termites and two soldiers of each of the following species R. flavipes (Eastern subterranean termite) and C. formosanus (Formosan subterranean termite) were added to each corresponding arena after assembly. A total of 20 arenas were used for this trial. Untreated control was water. Post-treatment observations were made daily for 5 days (a “day” or “days” are referred to herein with the abbreviation “d”). Data collected included distance tunneled and mortality.

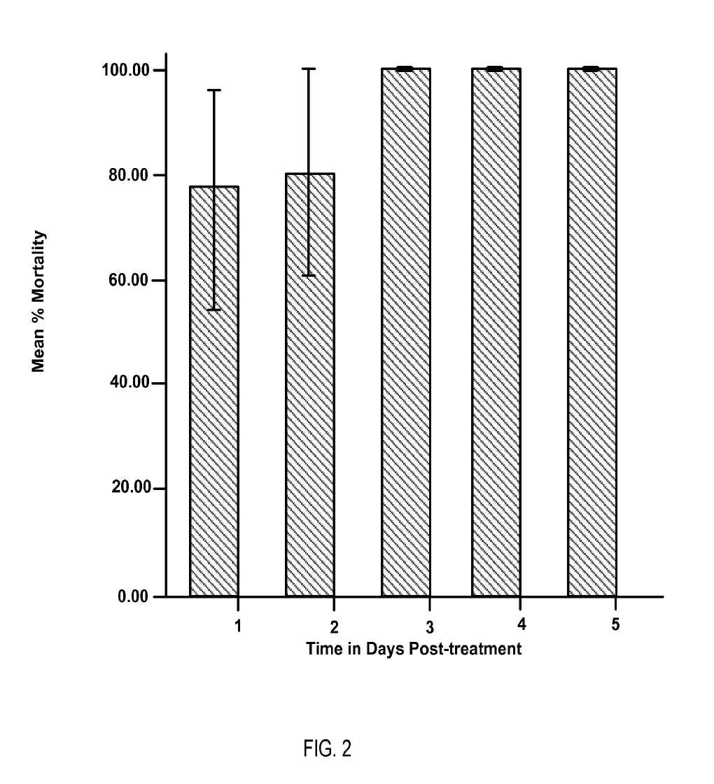

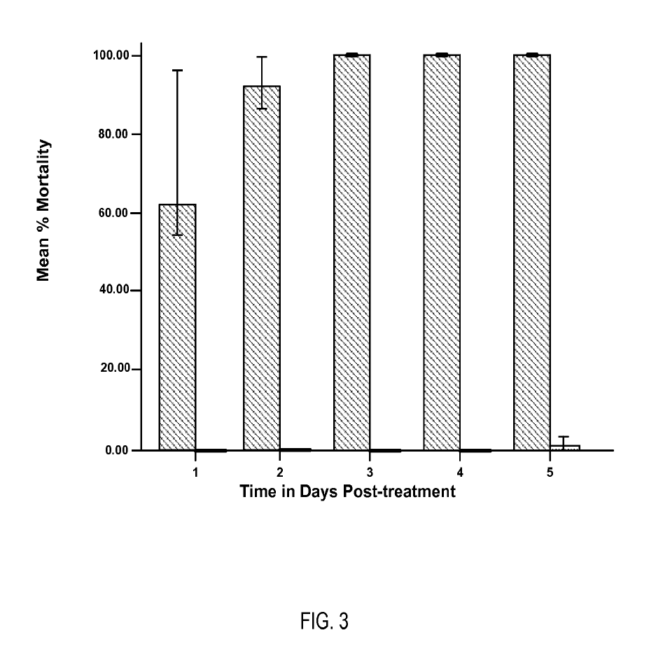

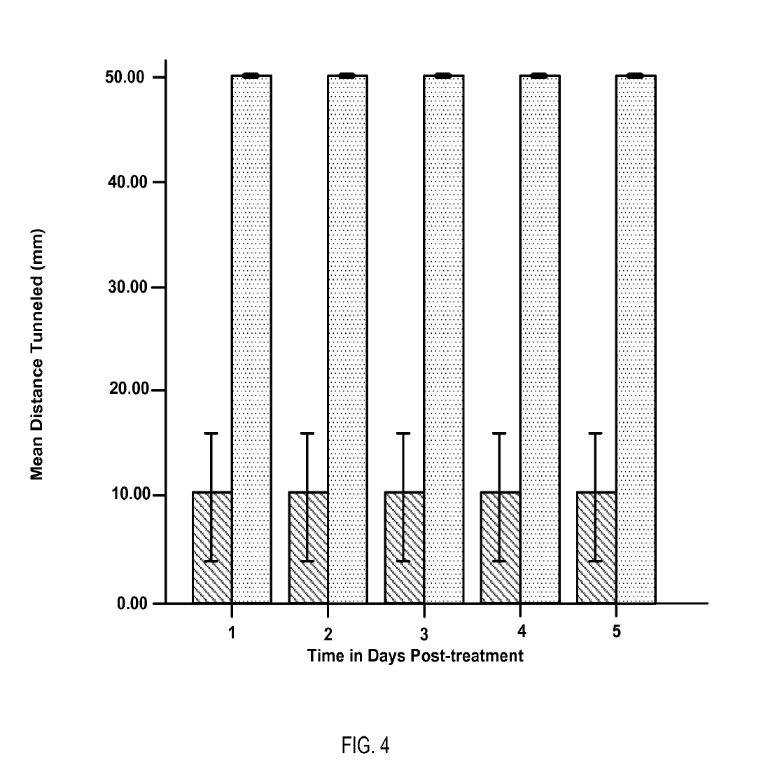

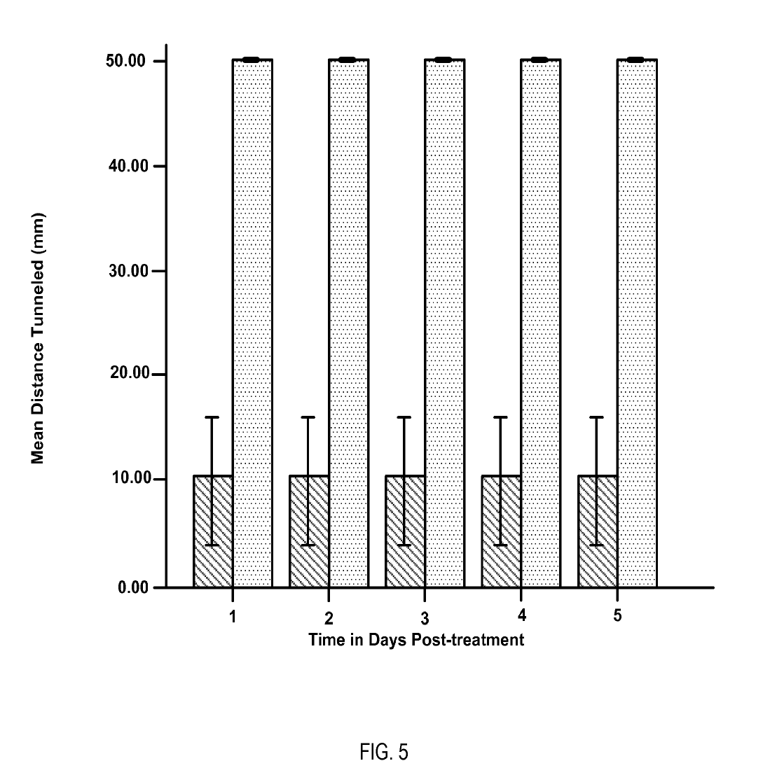

Exposure of both species of termite to 0.03% fipronil plus attractant resulted in 100% mortality at 3 d post-treatment and mortality in the treatments was significantly different (p=0.05) from that of the controls (FIG. 2, FIG. 3 and Table 1). The untreated controls were very active throughout the study and had minimal mortality throughout the duration of the study in both species. The mean distance tunneled by both species of termite in the treatments was 10.0 mm and tunneling distances in the treatments were significantly different (p=0.05) from the untreated controls (FIG. 4, FIG. 5 and Table 2). In the untreated controls, both species of termite tunneled the maximum distance of 50 mm in all replications at 1 d post-treatment. Due to the high mortality in the 0.03% fipronil plus attractant treatments at 1 d post-treatment, an LD₅₀ could not be calculated.

TABLE 1
Mean (5 replications) percent mortality of R. flavipes and
C. formosanus when exposed to soil treated with 0.03% fipronil
plus attractant over time. Means followed by the same letter
(e.g., “a” or “b”) in the same column associated
with the same species are not significantly different (p = 0.05).

| Treatment | Species | 1 d | 2 d | 3 d | 4 d | 5 d |
|---|---|---|---|---|---|---|
| Fipronil | R. | 77.0 a | 80.0 a | 80.0 a | 100.0 a | 100.0 a |
| 0.03% | flavipes | | | | | |
| Untreated | | 0.0 b | 0.0 b | 0.0 b | 0.0 b | 0.0 b |
| Control | | | | | | |
| Fipronil | C. formo- | 63.0 a | 93.0 a | 100.0 a | 100.0 a | 100.0 a |
| 0.03% | sanus | | | | | |
| Untreated | | 0.0 b | 0.0 b | 0.0 b | 0.0 b | 1.0 b |
| Control | | | | | | |

TABLE 2
Mean (5 replications) distance tunneled (mm) by R. flavipes
and C. formosanus in soil treated with fipronil 0.03% plus
attractant over time. Means followed by the same letter (e.g.,
“a” or “b”) in the same column associated with
the same species are not significantly different (p = 0.05).

| Treatment | Species | 1 d | 2 d | 3 d | 4 d | 5 d |
|---|---|---|---|---|---|---|
| Fipronil | R. | 10.0 a | 10.0 a | 10.0 a | 10.0 a | 10.0 a |
| 0.03% | flavipes | | | | | |
| Untreated | | 50.0 b | 50.0 b | 50.0 b | 50.0 b | 50.0 b |
| Control | | | | | | |
| Fipronil | C. formo- | 10.0 a | 10.0 a | 10.0 a | 10.0 a | 10.0 a |
| 0.03% | sanus | | | | | |
| Untreated | | 50.0 b | 50.0 b | 50.0 b | 50.0 b | 50.0 b |
| Control | | | | | | |

### Example 2

The effectiveness of compositions of the present disclosure in producing mortality in R. flavipes and C. formosanus is tested using an in vitro bioassay. Active subterranean termites are grown in 9 cm Petri dishes in the dark with 30 termites in each of seven dishes. A filter paper is placed on the bottom of each dish to retain moisture. A sample of treated soil is placed at one edge of each dish. The soil sample has been previously treated with water (as a control) or one of the following combinations for 30 minutes and then dried: 1) toxicant−commercial formulation rate (Tar); 2) toxicant−reduced rate (Trr); 3) toxicant−reduced rate plus adjuvant (Trr+Adj [Adj=a+b]); 4) toxicant−reduced rate plus partial adjuvant, component a (Trr+a); 5) toxicant−reduced rate plus partial adjuvant, component b (Trr+b); and, 6) adjuvant only (To+Adj). The termites are checked and recorded every hour for the first 12 hours and every 8 hrs thereafter. The observation period is 5 d. Termite mortality is recorded and compared for each time interval.

### Example 3

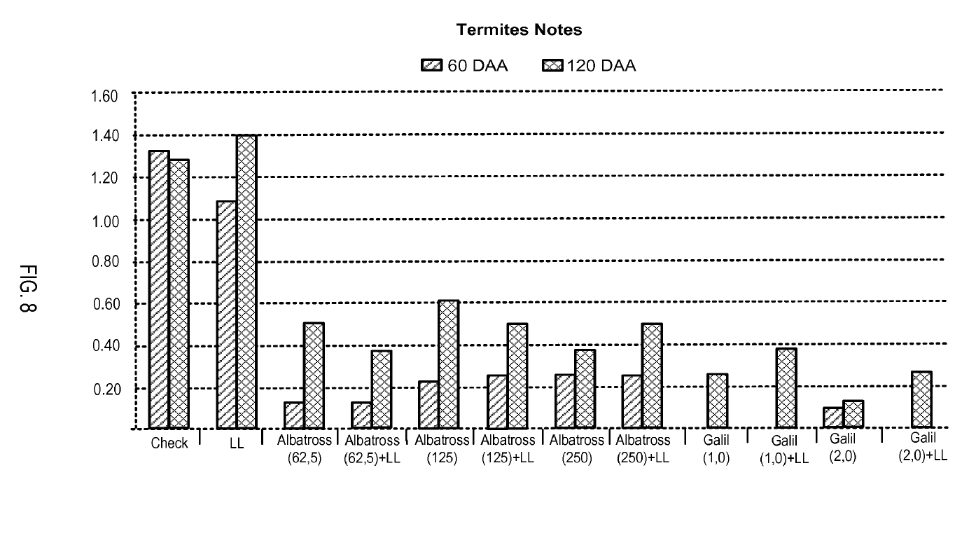

A bioassay study to evaluate termiticide efficacy in treated soil from the field is conducted similar to that described by Su et al., J. Econ. Entomol. 86: 772-776 (1993), and Gold et al., Sociobiology 28: 337-362 (1996), incorporated by reference in their entirety. Field test cells are established to evaluate termiticide efficacy under field conditions. The termiticide compositions are used for two treatments, concrete slab covered test cells and exposed ground (uncovered) test cells, each replicated three times. Each test cell was 2.25 feet square. Because of the wide range of Arizona soils, commercial topsoil (62.6% sand, 24.7% silt, and 12.7% clay, pH 8.2) is used after the native soil has been excavated from each test cell and discarded. This commercial soil mixture is occasionally used under foundation slabs and back fills. To differentiate treated soil from native soil for sampling, uncovered test cells are edged with 18 inch square frames constructed pine boards before filling with treated commercial soil. No other procedure is performed for the uncovered treatments, leaving the uncovered soil test cell treatments exposed to both sun and weather. The square frames for the covered treatments are filled with concrete to form 1 inch thick slabs. Construction wire in a FIG. 8 shape is placed inside the concrete slabs before setting to increase the strength and rigidity of the slabs. Furthermore, the covered treatments are constructed in such a way as to reduce the amount of radiant heat reaching the concrete slabs. Plywood covers (18 inches square) are mounted 2 inches above the concrete slabs on 6 inch bolts embedded in the concrete by using plastic spacers. The covers serve as shields from the direct sun and enabled air to flow between the slabs and the covers to minimize potential variation in residual analyses resulting from edge effects.

Soil samples are extracted from each test cell using a 2.54 cm by 19.0 cm stainless steel core sampler at 0, 6, 12, 24, 36, 48, and 60 months for bioassay analysis. Cores are taken directly in the uncovered test cells, whereas the covered mini-slabs must to be tilted to one side before sampling. After sample cores are taken in each test cell, white construction sand is used to fill the sample holes and the mini-slabs in the covered treatment are repositioned over the test cell. Initial samples are taken in the center of each test cell, with subsequent samples taken from north of center and proceeding clockwise. Soil cores are placed in re-closable plastic bags, labeled, and stored at 0° C.

Before the laboratory bioassay, soil samples are removed from the freezer and left to air dry for 24 h. Each soil sample is packed into a 15 cm by 15 mm by 12 mm i.d. glass tube forming a small core, 5 cm in length, in the middle of the tube. Agar plugs (0.5 cm) are positioned above and below each sample, sandwiching the soil core. Located below and in contact with the soil sample is a 3.5 cm by 5.5 cm rolled cardboard plug with a sliver of wood in the center to provide food and harborage for the termites. Twenty-three undifferentiated workers and two soldier termites from a single Heterotermes aureus colony are introduced into the top of each glass tube. Plastic caps are then placed over the bottom and top to prevent termites from escaping and to hold the sample in place. Bioassays, along with their controls, are replicated three times for each treatment and sampling date. All bioassays are held vertically at 29° C. and 90% relative humidity for 7 d before analysis.

Statistical analyses are performed using JMP 5.0.1 statistical software (SAS Institute 2002). Tunneling distances (bioassay analyses) of all termiticides and controls are examined over time using linear regression analysis. Significant differences among means for distance tunneled are identified using Tukey-Kramer multiple comparisons procedure (0.05). Additionally, tunneling activity by termites is recorded and scored over the course of the study and analyzed with logistic regression analysis. Logistic regression also is used to analyze termite mortality over the 5 year study with 100% bioassay mortality at 7 d assigned a value of 1 (successful) and mortality rates of less than 100% scored as 0 (unsuccessful).

### Example 4

Field testing was conducted to evaluate the efficacy of disclosed termiticide compositions comprising decreased rates of toxicants in protecting a cellulose food source from termite infestation. Testing was undertaken to ascertain the efficacy of the disclosed compositions using decreased rates of toxicant. Test grids having 20 test cells were established at the Santa Rita Experimental Range approximately 40 km south of Tucson, Ariz. (elevation 984 m, GPS coordinates N 31.88397: W 110.88375) with typical desert soil.

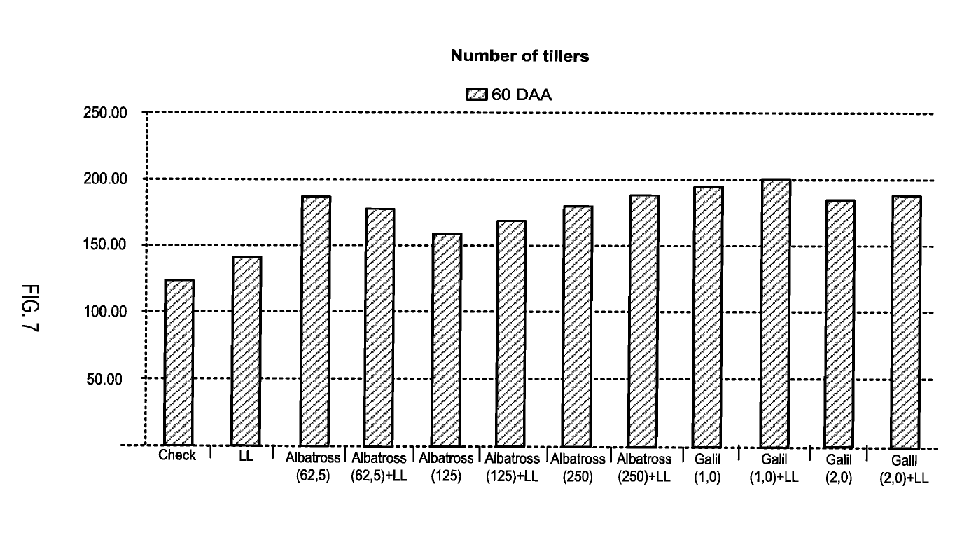

Each test cell comprised four concrete blocks wired together to enclose an area of approximately 2.25 square feet. A fifth concrete block was used as a cap to protect the test cell from the elements after treatment. After the treated soil within a test cell has dried, a 1 inch thick slab of concrete was cast in place over the treated soil, after which a roll of cardboard surrounding a wooden stake was placed vertically in the center of each test cell inside of PVC collar. Finally, the concrete block cap was put in place. FIG. 7 illustrates a test cell 10 in accordance with the present disclosure. In various embodiments, test cell 10 includes a square wood frame 20 enclosing a 2.25 square foot test cell, a 1 inch thick concrete slab 30 covering the treated soil within the test cell, a 6 inch diameter PVC collar 40 placed in the center of the test cell, and a 3 inch diameter roll of cardboard 50 surrounding a 1 inch diameter wood stake 60 place inside of the PVC collar.

Test treatments were performed using a test grid described above and a randomized distribution of ten repetitions of a control (check) and ten test formulations within the test grid. The control cells were treated with water. Test formulations for treated test cells comprise the composition having a reduced rate of toxicant and an attractant. The formulation 0.03% fipronil plus attractant was used. Each toxicant tested was subjected to testing in a 20 cell testing grid using the test treatment scheme described above.

Treatment rates and volumes were calculated to match toxicant rates for current label directions of commercial formulations for a horizontal preconstruction barrier treatment: one gallon of finished solution per 10 linear feet. Treatments were applied with a sprinkling can to the test cells. The effectiveness of treatments was determined by visual inspections at 30, 60, 90, 120, 270, 310 and 355 days post application. The concrete lids were removed, and the roll of cardboard and wooden stake were picked up, examined for evidence of termites and/or termite damage, and replaced. Termite activity was designated as the presence of termites, tunneling or soil tubes on or within the rolled cardboard.

A summary of the data collected is represented in Table 3. The mean termite activity for the treatment of fipronil SC was 10% with 2 of the observation dates having no termite activity. Some feeding was demonstrated initially and then the feeding stopped. In contrast, the check and the outside plot monitor had no dates without termite activity and substantially more termite activity at 45 and 42%, respectively. In addition the outside plot monitors confirmed the presence of termites by having termite activity every evaluation period with the last date having 70% (14/20). Based on the USDA criteria this experiment would not have failed the test at least to this point of one year post application.

TABLE 3
The percent of termite activity observed over the evaluation period
at the Santa Rita Experimental Range in southern Arizona.

| Date | Treatment | Check | Outside plot |
|---|---|---|---|
| 30 | 30 | 50 | 25 |
| 60 | 10 | 60 | 45 |
| 90 | 10 | 50 | 55 |
| 120 | 0 | 10 | 25 |
| 270 | 10 | 30 | 30 |
| 355 | 0 | 70 | 70 |
| Mean | 10 | 45 | 42 |

The treatment provided the expected control from fipronil plots despite the fact that it was applied at half the recommended rate.

### Example 5

Field testing is conducted to evaluate the efficacy of disclosed termiticide compositions comprising decreased rates of toxicants in protecting a cellulose food source from termite infestation, as compared to a treatment containing the same toxicant at the rate used in a commercial formulation. Testing is undertaken to ascertain the efficacy of the disclosed compositions using decreased rates of toxicant. Test grids of 7 test cells×7 test cells are established in an Arizona location with typical desert soil. Test cells are arranged as described above with reference to FIG. 1.

Test treatments are performed using a test grid described above and a randomized distribution of seven repetitions of a control and six different formulations within the test grid. The control cells are treated with water. Test formulations for treated test cells include the following treatments: 1) toxicant−commercial formulation rate (Tcfr); 2) toxicant−reduced rate (Trr); 3) toxicant−reduced rate plus adjuvant (Trr+Adj [Adj=a+b]); 4) toxicant−reduced rate plus partial adjuvant, component a (Trr+a); 5) toxicant−reduced rate plus partial adjuvant, component b (Trr+b); and, 6) adjuvant only (To+Adj). Each toxicant tested is subjected to testing in a 7 test cell×7 test cell testing grid using the test treatment scheme described above.

Treatment rates and volumes are calculated to match toxicant rates for current label directions of commercial formulations for a horizontal preconstruction barrier treatment: one gallon of finished solution per 10 linear feet. Treatments are applied with a sprinkling can to the test cells. The effectiveness of treatments is determined by visual inspections at three month intervals. The concrete lids are removed, and the roll of cardboard and wooden stake are picked up, examined for evidence of termites and/or termite damage, and replaced.

### Example 6

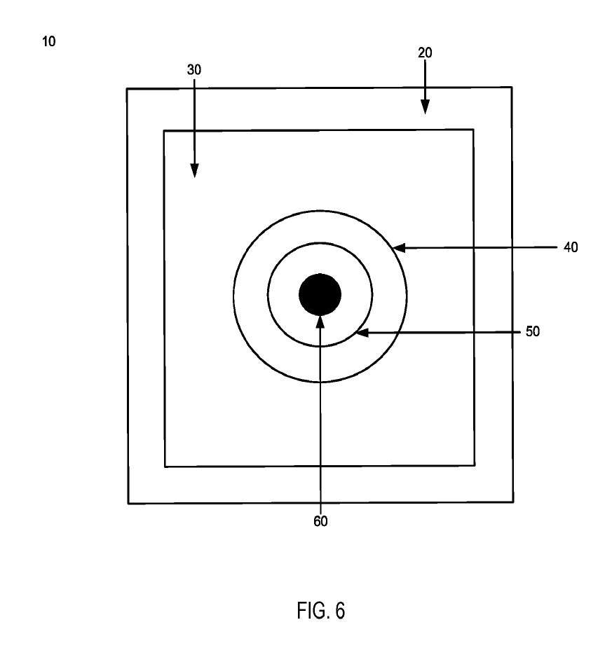

Field testing was conducted to evaluate the efficacy of disclosed termiticide compositions comprising decreased rates of toxicants in protecting a cellulose food source from termite infestation, as compared to a treatment containing the same toxicant at the rate used in a commercial formulation. Testing was undertaken to ascertain the efficacy of the disclosed compositions using decreased rates of toxicant. Test grids of 7 test cells×7 test cells were established in regions of Brazil (Usina Trapiche, Sirinhaém, PE and Usina Ibati, Ibati, PR). Test cells are arranged as described above with reference to FIG. 6.

A sugar cane RB867 515 variety was used for planting. The plants were distributed in furrows spaced 1.5 meters, on the 28th of May, 2013, followed by disking and plowing. The culture received 600 kg/ha of formulated fertilizer 083020, in the furrows before planting. The design was a randomized block design with twelve (12) plots and four (4) replicates, each plot occupying an area of 60 m² including four (4) rows from 1.5×10.0 m. The protocol and the products used in the experiment are shown in Table 4.

TABLE 4
Formulation treatments applied to the sugar cane plants.

| | | | | | Rate | |
|---|---|---|---|---|---|---|
| Nr. | Product | Form. | a.i. | g of ai/ha | (p.c. or g/ha) | Timming |
| 1 | Check | | | | | |
| 2 | Pheromone | | | | 1.0 ppm | IF |
| 3 | Albatross | 800WG | fipronil | 200 | 250 | IF |
| 4 | Albatross + Pheromone | 800WG | fipronil | 200 + ph | 250 + 1.0 ppm | IF |
| 5 | Albatross | 800WG | fipronil | 100 | 125 | IF |
| 6 | Albatross + Pheromone | 800WG | fipronil | 100 + ph | 125 + 1.0 ppm | IF |
| 7 | Albatross | 800WG | fipronil | 50 | 62.5 | IF |
| 8 | Albatross + Pheromone | 800WG | fipronil | 50 + ph | 62.5 + 1.0 ppm | IF |
| 9 | Galil | 300 SC | Imida + bifen | 500 + 100 + ph | 2000 | IF |
| 10 | Galil + Pheromone | 300 SC | Imida + bifen | 500 + 100 + ph | 2000 + 1.0 ppm | IF |
| 11 | Galil | 300 SC | Imida + bifen | 250 + 50 | 1000 | IF |
| 12 | Galil + Pheromone | 300 SC | Imida + bifen | 250 + 50 + ph | 1000 + 1.0 ppm | IF |

Albatross was fipronil (800 g/kg). Galil was imidacloprid+bifentrina (250+50 g/L). LL was Lab Lure (1 ppm; pheromone).

To control the termite (Tenuis Heterotermes), no insecticides were used at planting; after the distribution of billets; and before the cover was placed. The formulations were applied using a knapsack sprayer at the plant base at a rate equivalent to 100 liters per hectare of spray and pressure with a range of 30 cm. Treatments were applied at 2, 4, 6, 8, 10 and 12 days on stalks at planting. One application was administered on the ground at the opening of the furrow and another application on billets after they were deposited in the furrow before the closure (Table 4).

To determine the treatment on the termites (Tenuis Heterotermes), samples were taken after 60 and 120 days after application (DAA) of products. The number of tillers were determined 60 days after application (FIG. 7). The number of termites present in two (2) holes (trench 0.5×0.2×0.3 meters) 60 and 120 days after application were counted (FIG. 8). Treatment with Albatross (250)+LL demonstrated an increase in the number of tillers produced compared to treatment with Albatross alone (FIG. 7). Treatment with Albatross (62.5 and 125)+LL decreased the number of termites compared to treatment with Albatross alone (FIG. 8).

It is believed that the disclosure set forth above encompasses at least one distinct invention with independent utility. While various embodiments have been disclosed, the specific embodiments thereof as disclosed and illustrated herein are not to be considered in a limiting sense as numerous variations are possible. The subject matter of the disclosure includes all novel and non-obvious combinations and sub combinations of the various elements, features, functions and/or properties disclosed herein and their equivalents.

The composition and processes described herein may be used to manufacture pesticide or termiticide formulations having improved qualities and features. Other advantages and features of the present composition and processes may be appreciated from the disclosure herein and the implementation of the composition and processes.

What is claimed is:

1. A termiticide composition comprising:
a toxicant, an attractant, and an additive;
wherein a finished solution of a termiticide composition may be applied by spraying, and
wherein an effective rate of the toxicant in the finished solution is substantially reduced relative to an effective rate of the toxicant in a finished solution of a commercial formulation comprising the same toxicant.

2. The composition of claim 1, wherein the toxicant is selected from the group comprising fipronil, imidacloprid, and chlorfenapyr.

3. The composition of claim 1, wherein the attractant is 2-phenoxyethanol.

4. The composition of claim 1, wherein the additive is cellulose ether.

5. The composition of claim 1, wherein the additive is carboxymethylcellulose and the toxicant is fipronil.

6. A termiticide composition comprising a toxicant, an attractant and an additive,
wherein a finished solution of the termiticide composition is sprayable;
wherein the additive comprises an adjuvant or a cellulosic bait; and
wherein the adjuvant provides for an improved toxicant performance such that the termiticide composition achieves termite control using a substantially reduced rate of toxicant that is substantially similar to the termite control conferred by a toxicant rate of a commercial formulation.

7. The composition of claim 6, wherein the toxicant is selected from the group comprising fipronil, imidacloprid, and chlorfenapyr.

8. The composition of claim 6, wherein the attractant is a pheromone.

9. The composition of claim 6, wherein the cellulosic bait is carboxymethylcellulose.

10. The composition of claim 6, wherein the cellulosic bait is carboxymethylcellulose and the toxicant is fipronil.

11. A method of controlling termites using a reduced rate of toxicant comprising:
treating an area to be protected against termites using a treatment solution comprising an admixture of a toxicant, an attractant, and an additive,
wherein the toxicant is selected from a group comprising non-repellent termiticides, and
wherein the toxicant is effective at a rate that is substantially lower than a commercial formula toxicant rate due to admixture of the attractant and the additive with the toxicant in the treatment solution.

12. The method of claim 11, wherein the treatment solution is sprayable.

13. The method of claim 11, wherein the treatment solution is made by dilution of the admixture.

14. A method of controlling termites using a reduced rate of toxicant comprising:
selecting a toxicant from a group of chemicals comprising non-repellent termiticides;
selecting an additive;
selecting an attractant;
admixing the toxicant, additive, and attractant into a flowable composition;
diluting the composition to a finished solution;
applying the finished solution to an area to be protected;
wherein an effective rate of the toxicant in the finished solution is substantially lower than an effective rate of the toxicant in a commercial formulation.

15. The method of claim 14, wherein the area to be protected comprises a building structure.

16. The method of claim 14, wherein the area to be protected comprises an agronomic field.

17. The method of claim 14, wherein the area to be protected comprises plant stock.

18. The method of claim 14, wherein the area to be protected comprises seed.

19. The method of claim 14, wherein the finished solution is applied as a continuous barrier.

20. The method of claim 14, wherein the finished solution is applied as an interrupted barrier.

21. A method of improving plant vigor comprising:
administering a formulation comprising a termiticide, an attractant, and an additive.

22. The method of claim 21, wherein the termiticide is fipronil.

23. The method of claim 21 wherein the attractant is a pheromone.
